(19) United States
(12) Patent Application Publication
(10) Pub. No.: US 2009/0198623 A1
(43) Pub. Date: Aug. 6, 2009

(54) SYSTEM AND METHOD FOR EXECUTING AND AUTHENTICATING AN ACTIVITY AT A REMOTE LOCATION

(76) Inventor: Ran Rubinstein, Tel Aviv (IL)

Correspondence Address: Ran Rubinstein, 4 Dissentchik St. apt 2, Tel Aviv, 69353, omitted

(21) Appl. No.: 12/363,776

(22) Filed: Feb. 1, 2009

Related U.S. Application Data
(60) Provisional application No. 61/025,801, filed on Feb. 3, 2008.

(51) Int. Cl. G06Q 30/00; G06Q 10/00; G06Q 20/00

(52) U.S. Cl. 705/80; 705/9; 705/14

(57) ABSTRACT

Provided is a system and a method for executing a desired activity at a remote location, wherein said activity is ordered by individual in need thereof and is executed by a person incidentally occurring within a short range of the location who owns a Location-Aware Mobile Internet Device (LAMID), and who is ready to execute such activity and to verify its execution by sending evidence from the location using the LAMID.

### CROSS REFERENCE TO RELATED APPLICATIONS

The present invention claims priority from U.S. Provisional Application No. 61/025,801 filed Feb. 3, 2008.

### FIELD OF THE INVENTION

The present invention relates to the field of information technology (IT). More specifically, the present invention relates to a method of executing a service at a predetermined remote location by an anonymous person who authenticates the execution by transmitting a geographically tagged photograph, voice call, video call or video recording or audio recording from the location of said activity.

### BACKGROUND OF THE INVENTION

Modern communication and information technology has revolutionized the transfer and transport of physical goods and sheer information as well, and created undreamed possibilities for developing new services. The distances have contracted and times have shrunk, commercial transactions becoming incredibly simple. Cellular phones have become a worldwide success and phenomenon, with over 3 billion used worldwide. The latest generation of cellular phones are truly mobile computers, which have always-on Internet connection, photograph and video recording facilities, location-determination facilities such as GPS, and can run sophisticated custom software extending their use beyond usual phone communications. These latest devices, belonging to the class of Location-Aware Mobile Internet Devices (LAMID), have created an infrastructure for a new class of location based services, which are offered to owners of such devices based on their connection and location.

Provided are new opportunities for marketing, business, games, and education, and an ocean of Internet information becomes available. Myriads of location based services, often highly sophisticated, are offered. However, there are many simple situations in everyday life that bring uneasiness and even suffering, and in which a help is sought in vain and no service is offered. Take for example a traveler who is unsure whether he closed the windows before leaving the apartment; he might call his neighbors if he had any—but he unfortunately has no neighbors to call. It is therefore an object of the invention to provide a method that enables to an individual to have executed simple activities in a remote location and obtain a confirmation that the activity has been executed. Said simple activity can be as simple as taking a photograph and sending it to the person who requested the photo.

It is a further object of the invention to provide a system enabling to individuals to have a needed activity executed in their absence or at a remote event by an anonymous helper, the system comprising a service interface for ordering the activities to be executed and registering persons who are ready to execute such simple activities.

It is a still further object of the invention to provide a system matching the people in need of small activities in a remote location with ready to help persons, incidentally being near the location for said activity, the helpers being owners of LAMID devices and authenticating the execution by communicating evidence of the task performed, e.g. by sending a photo from their camera-phone.

The present invention enables to convert the plurality of anonymous phone owners to a web of potential helpers, thus creating a friendly sea of omnipresent neighbors always ready to help. Through this invention these phone owners have the opportunity to become location based service providers and receive awards for their efforts.

### SUMMARY OF THE INVENTION

The invention provides a system for executing a desired activity at certain time and location (said desired activity at a certain time and a certain location being called a task), and for verifying the execution of said task, wherein said task is defined by an individual in need thereof (task submitter), and wherein said activity is executed by a person incidentally occurring within a practical range of said time and location (task executor) who owns a Location-Aware Mobile Internet Device (LAMID), the system comprising i) a system manager interface which registers persons owning a LAMID who are ready to execute simple activities thus being potential executors, which system continuously accepts task descriptions from said submitters, and which communicates with said submitters and said potential executors; ii) a plurality of LAMIDs which are owned by said potential executors; iii) a database comprising at least task descriptions and the locations of said plurality of LAMIDs; and iii) a software enabling on-line processing of the data from said database. A system according to the invention preferably comprises authenticating the execution of said task by creating and transmitting an evidence selected from the group consisting of photograph, video recording, audio recording, phone call, and video call. In a preferred embodiment of the invention, said system comprises a server accessible from the Internet, a wireless communication system, a client software running on LAMIDs, a location information system, and a database relating to said LAMID owners. Said system continuously records desired activities as described by individuals communicating with said server, for each activity locating those LAMID owners who are within a practical range around the time and location of said task, while offering a reward for executing said activity, and receiving evidence such as a photograph, video recording, audio recording or live phone call or video call authenticating the execution. The description of said task obtained from said submitter may comprise location or a location range, time or time range, type of activity, and type of reward. Said time range may define the latest acceptable execution of said activity. Said reward may comprise more possibilities depending on the time of execution. Said reward may be negotiable. The term “practical” in regard to range, time, and space in the context of the invention means a short range, accessible by executors, and not discouraging them from executing the task.

The system according to the invention enables an individual to have a certain activity executed at remote locations by anonymous helpers. The system preferably comprises a software enabling financial transactions. In one embodiment, the invention provides a system which enables individuals, who need certain activities executed, whether said activities should occur at a remote location or in the absence of said individuals, to have said activities executed by anonymous helpers, comprising i) a server accessible from the Internet or by phone, continuously accepting descriptions of said needed activities to be executed at certain times and locations from said individuals; ii) a register of persons owning a LAMID, which persons are ready to execute simple activities for a reward, the register optionally comprising a database of maximal acceptable distances from the activity location and a minimal acceptable reward for said LAMID owners; iii) communication capabilities including client software running on the LAMID to report the location, to locate the LAMID owners, and to address those who are within an acceptable range around said time and location; iv) database including information about registered LAMID owners, information about the tasks, the data comprising LAMID locations, and reward offers and bids; and v) software enabling to process the data of said database, to match said individuals with said owners, to receive evidence from the proximity of said remote location, to transmit the evidence to said individuals, and to transact the rewards; wherein said persons occurring incidentally near said event become helpers to said individuals, and wherein said evidence authenticate the executions of said activities.

Said needed activity in a system according to the invention may comprise, for example, providing a photograph of a certain locality at a certain time, providing a photograph of a certain object or scene, entering certain area at a certain time, passing a message to a certain person, leaving a message at a certain location, transferring a small object between two close locations, documenting an unusual happening, documenting an accident, and broadcasting information from said location through a phone call or video call.

In one embodiment of the invention, a system is provided for executing a predetermined desired activity at an essentially precisely predetermined time and location (predetermined event), comprising verifying the execution of said activity by a photograph created and transmitted from said location by means of a camera-phone, and authenticating the precision of said time and location by a GPS-receiver incorporated in said camera-phone. Said system may comprise a service-providing interface and a service-ordering interface.

The system according to the invention is usually accessed by a plurality of individuals desiring a plurality of activities to be executed at various times and locations (various events), and by a plurality of persons owning a LAMID who are registered with said interface. A person in need of executing a certain task, the submitter, may offer a reward for executing said desired activity. Said reward may be set in advance. A system according to the invention may receive an agreement of a potential executor to execute said activity for an offered reward. The software of a system according to the invention may match said submitters with said potential executors, wherein said potential executors are owners of a LAMID registered with a service-providing interface, and wherein the execution of said activity at said time and location is verified and authenticated by evidence created at said time and location and transmitted from there by said LAMID to said interface.

The system according to the invention has preferably got an interface comprising continuously receiving from said submitters description of tasks to be executed, registering a plurality of potential executors, locating them, communicating with them, addressing potential executors who are located within a practical time and space range in regard to said tasks, offering rewards to said potential executors for executing said tasks and receiving their consents, receiving evidence recorded at said times and locations of said tasks, and transmitting the evidence to the submitters.

The invention, thus, relates to a method of executing a desired activity at certain time and location (a task), comprising verifying the execution of said task. Said task is defined by an individual in need thereof (task submitter), and said activity is executed by a person incidentally occurring within a practical range of said time and location (task executor) who owns a Location-Aware Mobile Internet Device (LAMID). Said method comprises i) registering persons owning a LAMID who are ready to execute simple activities, thus rendering them potential executors; ii) continuously accepting task descriptions from said submitters; iii) communicating with said submitters and said potential executors; iv) on-line processing data which include desired activities, LAMID positions, and information characterizing the potential executors, preferably pre-registered ones; v) locating and addressing potential executors who are located within a practical time and space range in regard to said tasks; vi) offering rewards to said potential executors for executing said tasks and receiving their consents; vi) receiving evidence recorded at said times and locations of said tasks, and vii) transmitting the evidence to the submitters. Said certain time and location may be an essentially precisely predetermined time and location (predetermined event); said verifying may comprise, for example, a photograph created and transmitted from said location by means of a camera-phone.

### BRIEF DESCRIPTION OF THE DRAWING

The principles and operation of the system according to the present invention may be better understood with reference to the following drawing and description, it being understood that the drawing and its description are given for illustrative purposes only and are not meant to be limiting, wherein:

FIG. 1 is a data flow diagram of an exemplary system described below which will allow task submitters and executors to interact in accordance with some embodiments of the invention.

### DETAILED DESCRIPTION OF THE INVENTION

Provided are the system and method for executing a desired activity at certain time and location (a task), and for verifying the execution of said task, wherein said task is defined by an individual in need thereof (task submitter), and wherein said activity is executed by a person incidentally occurring within a practical range of said time and location (task executor) who owns a Location-Aware Mobile Internet Device (LAMID). Said system enables, in one aspect, purchasing and selling services to be performed by owners of LAMID devices. This method provides assurance to the purchasing entity that its order will be received only by owners that are actually near the service location, thus reducing the risk of fraud by irrelevant users receiving the service request. LAMID owners (the potential service providers/executors) will preferably register with the system, providing their minimum requested fee for providing a service, and the maximum distance they are willing to travel from their current location in order to perform a service. The system will keep track of the registered users' location by installing software on their LAMID that will periodically report the registered users location to the system or by receiving such location information from a third party which collects such information, e.g. a cellular network carrier. Individuals wishing to purchase a service will interact with the server through a web site or any other method of communication, be it a mobile device or a human telephone operator. The purchasing individual will specify the nature of the service requested, location of the service requested (e.g. request for a current photograph of a building at a certain address). In response, the system will list the potential service providers (LAMID owners) and their minimum price for action. The purchasing entity can then decide to order this service. Even if there is no service provider near the location of the request—the request can be set to wait for potential service providers to arrive within practical distance of the service request. The purchasing individual can define a time frame in which it requests the service to be performed, and offer decreasing fees based on time performance as an incentive (e.g. $10 for a picture taken within one day, $1 for a picture taken within one week). Service providers near the requested service location, will receive notification that a service provision opportunity is available near their current location. This notification can be made through SMS or received when the software installed on their mobile device connects periodically to report the current location. The system will keep sending such notifications to service providers that arrive near the location of the request. Service providers can choose to get alerts only over a certain sum. The system will charge the purchasing entities and keep the fees in escrow until the purchasing entities agree to release them to the service provider—when the service has been provided to their satisfaction. A dispute resolve system will be in place, and individuals and service purchasers can be given rating, in order to give them an incentive to cooperate and perform the service correctly as described by a service provider, releasing escrow reward to a service executor that performed well. The individuals who need the activities to be executed, may contact the interface via their mobile phones, and some of these individuals may be registered in the system as LAMID owners and potential helpers, strengthening said web of potential helpers.

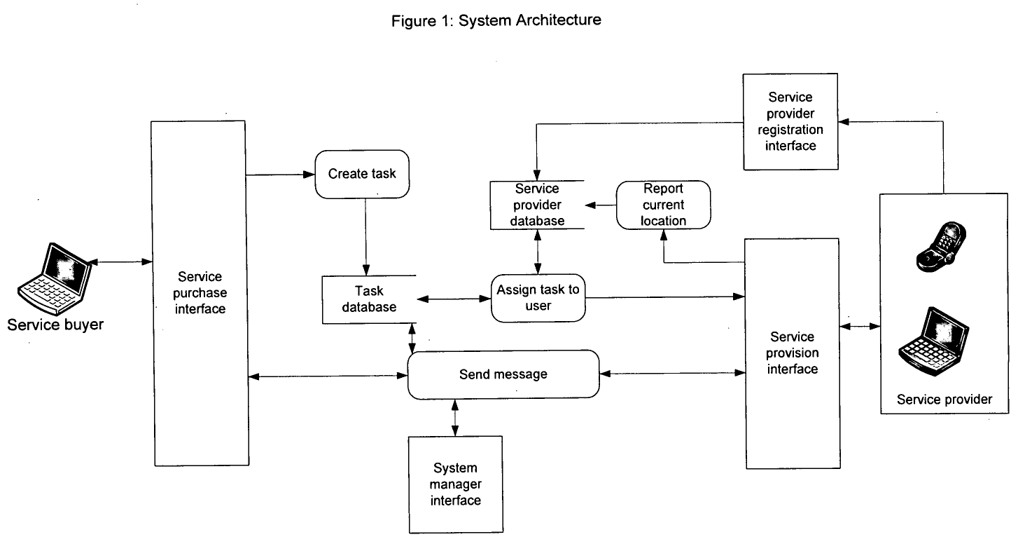

An exemplary embodiment of the system, shown in FIG. 1, is comprised of the following interfaces, described below: a service providers registration interface, a service purchase interface, and a service provision interface. The exemplary embodiment of the system contains two databases, a service provider database and a task database.

A service providers registration interface will collect from the person wishing to register as a service provider (task executor) the following information, fully or in part, and any other information required to contact and pay the service provider: email, mobile phone number, mobile phone model or capabilities, home and work addresses, the times that the service provider is present at these addresses, term of payment that the service provider requires. The service providers registration interface will then offer the service provider to install client software on his mobile device, which will provider the location authentication and real-time monitoring. Installing the client software is not required for becoming a service provider, but the providers installing the client software will receive a higher level of trust.

A service purchase interface will allow service buyers to select a location for the service to be performed, and provide the service terms and description to perform. The service purchase interface may include a map interface. The service purchase interface may display on a map interface the locations of potential service providers and their ratings, in order to assure the service buyer that his service request will be well- and quickly-performed. The service interface may communicate with the service buyer by email, mobile phone, instant messaging or any other method of communication to provide and collect information during the service progress. Communicated information may relate to a service provider accepting the service, a service provider completing a service, questions about the service by service providers, and tenders and bids on the required service.

A service provision interface will allow service providers to receive information about service they are potentially able to provide in their vicinity. The service provision interface communicate with the service provider through the client interface installed on their LAMID, or through any other means of communications such as email, mobile phone, SMS, instant messaging. The service provider will have an option to respond to the service request, ask for more information, state a requested fee for the service, or simply performing it and sending information as a reply to the system, through the client interface optionally installed on their LAMID, or through any other means of communications such as email, mobile phone, SMS, instant messaging. The system will then associate the reply with the service request and notify the service buyer of the service progress.

The LAMID client software will be installed on the service providers' phone and periodically monitor the service providers location and report it to the service provider interface. The LAMID client interface will include facilities for messaging, photography using the LAMID hardware, and monitoring of the LAMID location.

The invention is directed to a system and method for executing a desired activity at an essentially predetermined time and location (also called “event”), comprising verifying the execution of said activity by either asynchronous or synchronous evidence. Asynchronous means being a photograph, audio recording, or video recording created and transmitted from said location via an internet connection. Synchronous means being performing a voice or video call between the service provider and the individual who orders the service. The precision of the execution may be authenticated by a GPS-receiver or other location information service such as provided by a cellular carrier (cell tower, wifi hotspot location, etc). Said activity, as well as said time and location, are defined by an individual who is in need of executing said activity or obtaining information from a remote location, but who is absent at said location at said time, or who is generally far from the location. Said activity is executed by a person who owns a Location-Aware Mobile Internet Device (LAMID), with an Internet connection and optionally incorporating a camera (e.g. a camera-phone with GPS receiver such as Nokia N95, millions of which are currently deployed worldwide, or any other device, hand-held or car-mounted, that has these capabilities), and who is registered in a service-providing interface. The owner of a LAMID will install client software on the device, which will use the device hardware interface to take a photo or record a video or audio clip, or perform a video or audio call through the internet or cellular phone network, while simultaneously checking time and location information and attaching it to the photo, video or audio recording, or phone call and sending it through the server, so that the individual who orders the service, will get assurance that the service is indeed performed at the desired location. Said service-ordering interface is accessible by a web site or other means of communications, and is continually accessed by a plurality of individuals desiring a plurality of activities to be executed at various times and locations (various events); the interface connects the individuals with a plurality of persons owning a LAMID who are registered with said interface. Said service-ordering interface comprises a server and a software which are capable of evaluating said desired activities at various events, locating said registered persons, and addressing those of said registered persons who are near said events and who are ready to execute said activities. The term event in the context of the invention includes a situation, a location at a defined time point or within a time range, scene or landscape at a certain time, aftermath of a catastrophe, accident, a moment in a celebration, opening a door and entering a house, passing a defined parking site. The term activity, as well as the term task, may include anything that an absent individual might wish to effect but cannot, including feeding a pet in the house, checking whether the gas or window is closed, whether a certain object remained forgotten in the house entrance, whether an item lies lost in a location, ascertaining whether there is a traffic jam at a certain location etc. The activity may include moving small items, transferring them among neighbors, passing a message to an otherwise inaccessible person, etc. The activity may simply be an interview between the service provider (executor or potential executor) and individual who orders the service, in which the service provider provides real-time information about the location he is at. The system and method of the invention may comprise a service center for registering subscribers who wish to either provide service, or receive service, or both.

In an asynchronous service order, the activity comprises photo-, audio- or video-documenting a location at a certain time, i.e. photographing an event. Tourists may wish to see a current photo of a village which they consider to visit, a buyer would like to see a current unbiased picture of a far-away real estate before traveling there, a person searching for a friend wonders whether the friend's car is present on the parking lot, etc. Photographed can be a small item in a shop or a book in a bookstore or library. Of course, many other documenting and non-documenting activities are enabled by this invention. Asynchronous activities are authenticated by sending a photo, audio or video recording from the location, to which the client software attaches a location and time stamp; in some cases the photo or video recording itself is the goal, in other the photo or video recording merely verifies the right location at a right time. Synchronous activities do not need time stamping, as they include real-time interaction between the service provider and the individual who orders the service. For synchronous activities, location of the service provider is determined by the client software, through which the phone call or video call is initiated.

Said individual in need of said activity offers a reward for executing said desired activity, possibly depending on the precise timing or location. In the method of the invention, registered persons who own the LAMID means may accept a reward offered by the service provider and may execute said activity. The reward offered by said individuals (submitters) will be usually higher than the reward offered to said registered persons (executors), with the difference being the commission taken by the system provider. Said reward may comprise a service given to the executor by the system provider. In another embodiment of the invention, said reward may be merely symbolical, or non-financial.

Thus, provided is a method of matching individuals needing certain activities to be executed at certain events with persons capable of executing said activities, wherein said persons are owners of a LAMID registered with a service-providing interface, and wherein the execution of said activity at said events is verified and authenticated either asynchronously or synchronously. The former comprising, for example, a photograph, audio or video recording, created at said event and transmitted from there by said LAMID to the central server via client software installed on the LAMID, which attaches time and location information to the photograph, audio or video recording in a tamperproof way; the latter comprising, for example, a phone call or video call initiated by the server between the two parties, while the client software installed on the LAMID reports the location of the service provider.

A method according to the invention preferably comprises registering a plurality of owners of a LAMIDs, locating said owners while simultaneously communicating with them, and continuously receiving from a plurality of said individuals the description of activities to be executed. Said simultaneous communicating comprises addressing owners who are located within a practical time and space range around said events and offering them rewords for executing said activities, receiving their consents, receiving the photographs taken near said events, and transmitting the photographs to the corresponding individuals. The term “practical range” means the maximal acceptable distance between said event and the time-space location of the LAMID owner, which will be usually defined by the owner during the registration. Only service providers that have the opportunity to perform the service, based on their location, receive notification of the service request—this features reduces potential fraud.

The invention is directed to a system for executing desired activities near predetermined times and locations (near predetermined events) and for authenticating the execution of said activities, wherein the activities are defined by individuals in need thereof and are executed by persons incidentally occurring within a practical range of said events who own a LAMID, and wherein the execution is authenticated by creating and transmitting a photograph or video recording documenting the event. A system according to the invention may comprise a server accessible from the Internet, a wireless communication system, a client software which utilizes camera and positioning system, and a database of said LAMID owners. The system continuously records desired activities as described by individuals communicating with said server, and for each activity it locates those LAMID owners who are within a practical range around said event, offering a reward for executing said activity, and receiving a photograph or video recording authenticating the execution. The description of a desired activity obtained by an individual comprises location, time range, type of activity, and reward. Said time range may define the latest acceptable execution of said activity; more reward values may be offered depending on the time of execution. In a system according to the invention, said reward may be negotiable. In case that many registered persons are around, of course the activity will be executed simply on the first offer. More complicated or exotic activities may include a negotiation.

While the invention has been described using some specific examples, other modifications and variations are possible, as it enables a wide range of new service opportunities to be provided by LAMID owners.

1. A system for executing a desired activity at certain time and location (a task), and for verifying the execution of said task, wherein said task is defined by an individual in need thereof (task submitter), and wherein said activity is executed by a person incidentally occurring within a practical range of said time and location (task executor) who owns a Location-Aware Mobile Internet Device (LAMID), the system comprising
i) a system manager interface which registers persons owning a LAMID who are ready to execute simple activities thus being potential executors, which system continuously accepts task descriptions from said submitters, and which communicates with said submitters and said potential executors;
ii) a plurality of LAMIDs which are owned by said potential executors;
iii) a database comprising at least task descriptions and the locations of said plurality of LAMIDs; and
iii) a software enabling on-line processing of the data from said database.

2. A system according to claim 1, comprising authenticating the execution of said task by creating and transmitting an evidence selected from the group consisting of photograph, video recording, audio recording, phone call, and video call.

3. A system according to claim 1, comprising a server accessible from the Internet, a wireless communication system, a client software running on LAMIDs, location information system, and a database relating to said LAMID owners.

4. A system according to claim 1, continuously recording desired activities as described by individuals communicating with said server, for each activity locating those LAMID owners who are within a practical range around the time and location of said task, offering a reward for executing said activity, and receiving evidence such as a photograph, video recording, audio recording or live phone call or video call authenticating the execution.

5. A system according to claim 1, wherein the description of said task obtained from said submitter comprises location or a location range, time or time range, type of activity, and type of reward.

6. A system according to claim 5, wherein said time range defines the latest acceptable execution of said activity, and wherein said reward may comprise more possibilities depending on the time of execution, said reward optionally being negotiable.

7. A system according to claim 1, enabling individuals to have a certain activity executed at remote locations by anonymous helpers.

8. A system according to claim 1, wherein said software enables financial transactions.

9. A system according to claim 1, enabling individuals to have needed activities executed at a remote location or in their absence by anonymous helpers, comprising
i) a server accessible from the Internet or by phone, continuously accepting descriptions of said needed activities to be executed at certain times and locations from said individuals;
ii) a register of persons owning a LAMID, which persons are ready to execute simple activities for a reward, the register optionally comprising a database of maximal acceptable distances from the activity location and a minimal acceptable reward for said LAMID owners;
iii) communication capabilities including client software running on the LAMID to report the location, to locate the LAMID owners, and to address those who are within an acceptable range around said time and location;
iv) database including information about registered LAMID owners, information about the tasks, the data comprising LAMID locations, and reward offers and bids; and
v) software enabling to process the data of said database, to match said individuals with said owners, to receive evidence from the proximity of said remote location, to transmit the evidence to said individuals, and to transact the rewards;
wherein said persons occurring incidentally near said event become helpers to said individuals, and wherein said evidence authenticate the executions of said activities.

10. A system according to claim 1, wherein said needed activity is selected from the group consisting of providing a photograph of a certain locality at a certain time, providing a photograph of a certain object or scene, entering certain area at a certain time, passing a message to a certain person, leaving a message at a certain location, transferring a small object between two close locations, documenting an unusual happening, documenting an accident, and broadcasting information from said location through a phone call or video call.

11. A system according to claim 1, for executing a predetermined desired activity at an essentially precisely predetermined time and location (predetermined event), comprising verifying the execution of said activity by a photograph created and transmitted from said location by means of a camera-phone, and authenticating the precision of said time and location by a GPS-receiver incorporated in said camera-phone.

12. A system according to claim 1, comprising a service-providing interface and a service-ordering interface.

13. A system according to claim 1, accessed by a plurality of individuals desiring a plurality of activities to be executed at various times and locations (various events), and by a plurality of persons owning a LAMID who are registered with said interface.

14. A system according to claim 1, wherein said submitter offers a reward for executing said desired activity.

15. A system according to claim 1, wherein a potential executor agrees to execute said activity for an offered reward.

16. A system according to claim 1 in which said software matches said submitters with said potential executors, wherein said potential executors are owners of a LAMID registered with a service-providing interface, and wherein the execution of said activity at said time and location is verified and authenticated by evidence created at said time and location and transmitted from there by said LAMID to said interface.

17. A system according to claim 1, comprising continuously receiving from said submitters description of tasks to be executed, registering a plurality of potential executors, locating them, communicating with them, addressing potential executors who are located within a practical time and space range in regard to said tasks, offering rewards to said potential executors for executing said tasks and receiving their consents, receiving evidence recorded at said times and locations of said tasks, and transmitting the evidence to the submitters.
